(19) United States
(12) Patent Application Publication
(10) Pub. No.: US 2014/0064190 A1
(43) Pub. Date: Mar. 6, 2014

(54) APPARATUS AND METHOD FOR DETECTING LTE UPLINK RANDOM ACCESS PREAMBLE BASED ON PARALLEL PROCESSING

(71) Applicant: ELECTRONICS AND TELECOMMUNICATIONS RESEARCH INSTITUTE, Daejeon-city (KR)

(72) Inventor: Joohyun LEE, Daejeon (KR)

(73) Assignee: ELECTRONICS AND TELECOMMUNICATIONS RESEARCH INSTITUTE, Daejeon-city (KR)

(21) Appl. No.: 14/016,834

(22) Filed: Sep. 3, 2013

(30) Foreign Application Priority Data
Sep. 3, 2012 (KR) 10-2012-0097009
Jul. 23, 2013 (KR) 10-2013-0086852

(51) Int. Cl. H04W 74/08

(52) U.S. Cl. CPC H04W 74/0833
USPC 370/328

(57) ABSTRACT

Disclosed herein is an apparatus and method for detecting an LTE uplink random access preamble based on parallel processing. The apparatus for detecting an LTE uplink random access preamble based on parallel processing according to the present invention includes a generation unit for calculating a random access preamble sequence using a root index and generating channel delay profile data using the random access preamble sequence and a channel delay profile generation input signal. A comparison unit generates a preamble start position value corresponding to the root index and compares the preamble start position value with a channel delay profile index. A detection unit detects a peak value of the channel delay profile data if the preamble start position value is identical to the channel delay profile index.

### CROSS REFERENCE TO RELATED APPLICATIONS

This application claims the benefit of Korean Patent Application Nos. 10-2012-0097009, filed on Sep. 3, 2012 and 10-2013-0086852, filed on Jul. 23, 2013, which are hereby incorporated by reference in their entireties into this application.

### BACKGROUND OF THE INVENTION

1. Technical Field

The present invention relates generally to an apparatus and method for detecting a Long Term Evolution (LTE) uplink random access preamble based on parallel processing and, more particularly, to an apparatus and method for detecting an LTE uplink random access preamble based on parallel processing, which can more rapidly detect an LTE uplink random access preamble by processing the generation of channel delay profile data in parallel.

2. Description of the Related Art

Recently, with the development of wireless communication technology, Long Term Evolution (LTE) wireless data packet communication standards have been widely used. LTE is generally configured such that a terminal device receives a downlink signal from a base station and then transmits an uplink random access preamble to the base station so as to register itself on the base station.

In the base station that receives the LTE uplink random access preamble, the generation of a channel delay profile requires a high computational load and a long delay time, which are directly associated with the processing capacity of the base station. Accordingly, in LTE communication, the time required to generate a channel delay profile has been regarded as an important factor.

Korean Patent Application Publication No. 2012-0083512 relates to a random access method for a wireless communication system, the wireless communication system, a wireless terminal, and a base station device, and presents a configuration using a single signature in a terminal device.

However, such conventional technology for detecting an LTE uplink random access preamble does not present a detailed technique regarding which scheme can be used to shorten the time required to generate a channel delay profile.

Therefore, there is urgently required new technology for detecting an LTE uplink random access preamble, which can more rapidly detect an LTE uplink random access preamble by processing in parallel the generation of pieces of channel delay profile data respectively corresponding to one or more root indices so as to promptly generate a channel delay profile.

### SUMMARY OF THE INVENTION

Accordingly, the present invention has been made keeping in mind the above problems occurring in the prior art, and an object of the present invention is to enable an LTE uplink random access preamble to be more rapidly detected by processing in parallel the generation of pieces of channel delay profile data respectively corresponding to one or more root indices.

Another object of the present invention is to compare preamble start position values corresponding to one root index due to the Doppler effect with a channel delay profile index, thus more promptly canceling the influence of the Doppler effect.

A further object of the present invention is to previously prepare for a random access preamble sequence using a root index before the storage of preamble data in a buffer is completed, thus more rapidly generating channel delay profile data.

In accordance with an aspect of the present invention to accomplish the above objects, there is provided an apparatus for detecting a Long Term Evolution (LTE) uplink random access preamble based on parallel processing, including a generation unit for calculating a random access preamble sequence using a root index and generating channel delay profile data using the random access preamble sequence and a channel delay profile generation input signal; a comparison unit for generating a preamble start position value corresponding to the root index and comparing the preamble start position value with a channel delay profile index; and a detection unit for detecting a peak value of the channel delay profile data if the preamble start position value is identical to the channel delay profile index.

Preferably, the generation unit may process generation of pieces of channel delay profile data respectively corresponding to a plurality of root indices in parallel.

Preferably, the comparison unit may additionally generate preamble start position values respectively corresponding to the root indices in consideration of a shift of the peak value in the random access preamble sequence due to Doppler effect.

Preferably, the detection unit may be configured to, if each preamble start position value is identical to the channel delay profile index, accumulate pieces of channel delay profile data in preamble sections including preamble start position values for respective root indices, and detect a peak value of the accumulated channel delay profile data.

Preferably, the apparatus may further include an identifier acquisition unit for acquiring preamble identifiers corresponding to the preamble start position values if the peak value has been detected.

Preferably, the apparatus may further include a distance acquisition unit for acquiring a distance to a base station using a difference between a corresponding preamble start position value and a peak position value.

Preferably, the comparison unit may generate the preamble start position values allocated to random access preamble sequences calculated using the root indices.

Preferably, the generation unit may be configured to, before storage of preamble data in a buffer is completed, calculate random access preamble sequences using the root indices, and if storage of the preamble data in the buffer has been completed, receive the channel delay profile generation input signal from the buffer.

Preferably, the generation unit may convert an index corresponding to the channel delay profile data and then generate the channel delay profile index.

Preferably, the generation unit may proportionally convert the index corresponding to the channel delay profile data into a value ranging from 0 to 838, and then generate the channel delay profile index.

In accordance with another aspect of the present invention to accomplish the above objects, there is provided a method of detecting a Long Term Evolution (LTE) uplink random access preamble based on parallel processing, including calculating a random access preamble sequence using a root index and generating channel delay profile data using the random access preamble sequence and a channel delay profile generation input signal; generating a preamble start position value corresponding to the root index and comparing the preamble start position value with a channel delay profile index; and detecting a peak value of the channel delay profile data if the preamble start position value is identical to the channel delay profile index.

Preferably, generating the channel delay profile data may be configured to process generation of pieces of channel delay profile data respectively corresponding to a plurality of root indices in parallel.

Preferably, comparing the preamble start position value with the channel delay profile index may be configured to additionally generate preamble start position values respectively corresponding to the root indices in consideration of a shift of the peak value in the random access preamble sequence due to Doppler effect.

Preferably, detecting the peak value of the channel delay profile data may be configured to, if each preamble start position value is identical to the channel delay profile index, accumulate pieces of channel delay profile data in preamble sections including preamble start position values for respective root indices, and detect a peak value of the accumulated channel delay profile data

Preferably, the method may further include acquiring preamble identifiers corresponding to the preamble start position values if the peak value has been detected.

Preferably, the method may further include acquiring a distance to a base station using a difference between a corresponding preamble start position value and a peak position value.

Preferably, comparing the preamble start position value with the channel delay profile index may be configured to generate the preamble start position values allocated to random access preamble sequences calculated using the root indices.

Preferably, generating the channel delay profile data may be configured to, before storage of preamble data in a buffer is completed, calculate random access preamble sequences using the root indices, and if storage of the preamble data in the buffer has been completed, receive the channel delay profile generation input signal from the buffer.

Preferably, generating the channel delay profile data may be configured to convert an index corresponding to the channel delay profile data and then generate the channel delay profile index.

Preferably, generating the channel delay profile data may be configured to proportionally convert the index corresponding to the channel delay profile data into a value ranging from 0 to 838, and then generate the channel delay profile index.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing an example of an apparatus for detecting an LTE uplink random access preamble based on parallel processing according to an embodiment of the present invention;

FIG. 2 is a diagram showing an example of a system to which the apparatus for detecting an LTE uplink random access preamble based on parallel processing according to the present invention is applied;

FIG. 3 is a diagram showing an example of parallel processing according to the present invention;

FIG. 4 is a diagram showing an example of channel delay profile data according to the present invention; and

FIG. 5 is an operation flowchart showing an example of a method of detecting an LTE uplink random access preamble based on parallel processing according to an embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, preferred embodiments of the present invention will be described in detail with reference to the attached drawings.

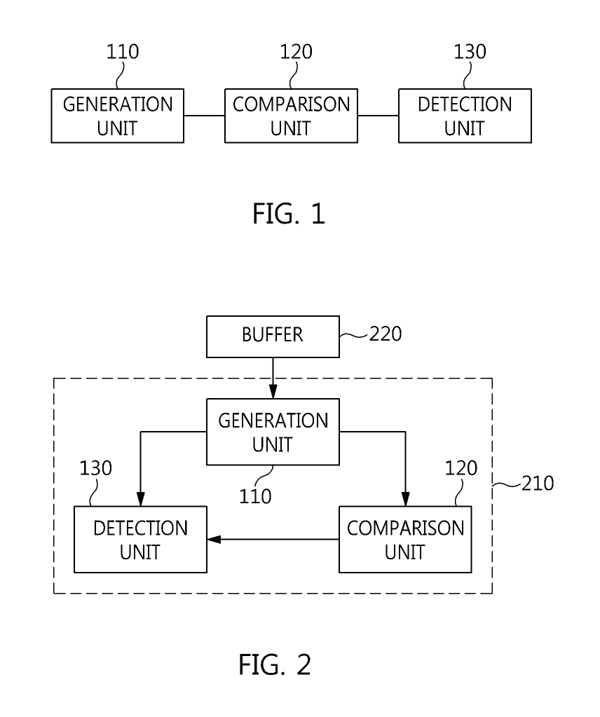

FIG. 1 is a block diagram showing an example of an apparatus for detecting a Long Term Evolution (LTE) uplink random access preamble based on parallel processing according to an embodiment of the present invention.

Referring to FIG. 1, the LTE uplink random access preamble detection apparatus based on parallel processing according to the embodiment of the present invention includes a generation unit 110, a comparison unit 120, and a detection unit 130.

The generation unit 110 calculates a random access preamble sequence using a root index, and generates channel delay profile data using the random access preamble sequence and a channel delay profile generation input signal.

In this case, the value of the root index may be a value preset by a base station.

The root index may include a plurality of root indices.

Here, a single random access preamble sequence, a single channel delay profile generation input signal, and a single piece of channel delay profile data may correspond to a single root index.

For example, the generation unit 110 may calculate a first random access preamble sequence using a first root index q₁, and may generate first channel delay profile data by additionally using a first channel delay profile generation input signal.

In this case, the generation unit 110 may generate random access preamble sequences respectively corresponding to a plurality of root indices using the root indices so as to include a plurality of random access preambles in the random access preamble sequences.

The length of each random access preamble sequence may be 839.

The random access preamble sequence may be a Zadoff-Chu sequence.

Here, the generation unit 110 may calculate random access preamble sequences using root indices before the storage of the preamble data in the buffer is completed and may receive a channel delay profile generation input signal from the buffer if the storage of the preamble data in the buffer has been completed.

For example, the generation unit 110 may calculate the first random access preamble sequence using the first root index q₁ before the storage of preamble data in the buffer is completed, and may receive a first channel delay profile generation input signal q_{1,in} from the buffer and generate first channel delay profile data q_{1,out} if the storage of the preamble data in the buffer has been completed.

In this case, the generation unit 110 may process in parallel the generation of pieces of channel delay profile data q_{1,out} to q_{n,out} respectively corresponding to the plurality of root indices q₁ to qₙ.

The generation unit 110 may process, in a pipeline manner, the generation of pieces of channel delay profile data q_{1,out} to q_{n,out} respectively corresponding to the plurality of root indices q₁ to qₙ.

For example, the generation unit 110 may process in parallel the generation of the first channel delay profile data q_{1,out} corresponding to the first root index q₁ and the generation of second channel delay profile data q_{2,out} corresponding to a second root index q₂.

In this way, the output of second channel delay profile data q_{2,out} starts subsequently to the termination of the output of the first channel delay profile data q_{1,out} due to the parallel processing of the generation unit 110, so that the delay time other than the time T_{pipelineDelay} required to generate the first channel delay profile data may be reduced.

In this case, the time N_{FFT} required to detect the peak value of the channel delay profile data may be the time required to perform a Fast Fourier Transform (FFT) on the channel delay profile data.

The preamble data may be data in which a Cyclic Prefix (CP) part is eliminated from an uplink signal.

Further, the preamble data may be obtained by extracting a frequency interval including a random access preamble from a time interval (Physical Random Access Channel: PRACH subframe) signal agreed upon between the base station and the terminal by using a demultiplexer.

Furthermore, the preamble data may be obtained by performing a FFT.

Furthermore, the preamble data may be obtained by performing Orthogonal Frequency Division Multiplexing (OFDM) demodulation.

Furthermore, the preamble data may be data of a frequency domain.

In this case, the generation unit 110 may convert an index corresponding to channel delay profile data and generate a channel delay profile index.

In this case, the index corresponding to the channel delay profile data may correspond to a value ranging from 0 to N.

In this case, the generation unit 110 may proportionally convert an index corresponding to the channel delay profile data into a value ranging from 0 to 838, and then generate the channel delay profile index.

The comparison unit 120 may generate a preamble start position value corresponding to a root index and compare the preamble start position value with the channel delay profile index.

In this case, the comparison unit 120 may additionally generate preamble start position values respectively corresponding to root indices in consideration of the shift of the peak value in the random access preamble sequence due to the Doppler effect.

For example, the comparison unit 120 may additionally generate preamble start position values on the left and right sides of the existing preamble start position value in consideration of the shift of the peak value in the random access preamble sequence due to the Doppler effect.

In this way, the comparison unit 120 may generate three preamble start position values corresponding to a single root index in consideration of the shift of the peak value in the random access preamble sequence due to the Doppler effect.

Further, the comparison unit 120 may generate the preamble start position value allocated to the random access preamble sequence calculated using the root index.

The detection unit 130 detects the peak value of channel delay profile data when the preamble start position value is identical to the channel delay profile index.

In this case, the detection unit 130 may detect the peak value of the channel delay profile data in a preamble section including the preamble start position value if the preamble start position value is identical to the channel delay profile index.

For example, the detection unit 130 may be configured to, if the preamble start position value is 0 and the channel delay profile index is 0, and then the two values are identical to each other, detect the peak value of channel delay profile data in a preamble section including the preamble start position value of 0.

In this case, the detection unit 130 may be configured to, if the preamble start position value and the channel delay profile index are identical to each other, accumulate pieces of channel delay profile data in preamble sections including preamble start position values for respective root indices, and detect the peak value of the accumulated channel delay profile data.

The length of the preamble section may be a value preset by the base station.

In this case, the detection unit 130 may be configured to, when the preamble start position value corresponds to a restricted set in which the Doppler effect is considered, accumulate pieces of channel delay profile data in preamble sections including the preamble start position values for respective root indices, and detect the peak value of the accumulated channel delay profile data.

In this case, the detection unit 130 gradually increases the channel delay profile index from 0 and then makes the channel delay profile index identical to the preamble start position value.

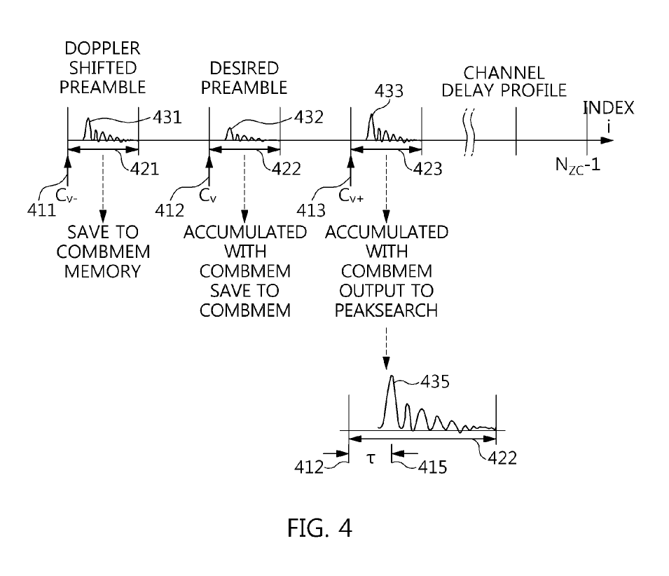

For example, referring to FIG. 4, the detection unit 130 is configured to, if the preamble start position values are Cᵥ₋ 411, Cᵥ 412, and Cᵥ₊ 413, gradually increase the channel delay profile index from 0, store the channel delay profile data 431 of a preamble section 421 including Cᵥ₋ 411 when the channel delay profile index is Cᵥ₋ 411, add the channel delay profile data 432 of a preamble section 422 including Cᵥ 412 to the data 431 and store accumulated data when the channel delay profile index is Cᵥ 412, and additionally add the channel delay profile data 433 of a preamble section 423 including Cᵥ₊ 413 to the accumulated data of the data 431 and the data 432, and detect the peak value of resulting data 435 when the channel delay profile index is Cᵥ₊ 413.

In this case, the pieces of channel delay profile data 431 and 432 may be stored in a memory block.

Meanwhile, the detection unit 130 may be configured to, when the preamble start position value corresponds to an unrestricted set in which the Doppler effect is not considered, detect the peak value of channel delay profile data in a preamble section including the preamble start position value.

In this way, the detection unit 130 may accumulate pieces of channel delay profile data processed in parallel, and then promptly obtain accumulated channel delay profile data.

As described above, the detection unit 130 may reduce the influence of the shift of a peak value in a random access preamble sequence due to the Doppler effect by accumulating pieces of channel delay profile data for respective root indices.

In this case, the LTE uplink random access preamble detection apparatus based on parallel processing according to the embodiment of the present invention may further include an identifier acquisition unit for acquiring preamble identifiers corresponding to preamble start position values when peak values are detected.

In this case, the number of preamble identifiers may be 64.

For example, the identifier acquisition unit may acquire a preamble identifier corresponding to the preamble start position value 412 of the preamble section 422 in which the peak value is detected.

In this case, the LTE uplink random access preamble detection apparatus based on parallel processing according to the embodiment of the present invention may further include a distance acquisition unit for acquiring a distance to the base station using a difference between the preamble start position value and a peak position value if the peak value has been detected.

For example, the distance acquisition unit may acquire the distance to the base station using a difference between the preamble start position value 412 and the peak position value 415 of the preamble section 422 in which the peak value is detected.

FIG. 2 is a diagram showing an example of a system to which the apparatus for detecting an LTE uplink random access preamble based on parallel processing according to the present invention is applied.

Referring to FIG. 2, the system to which the LTE uplink random access preamble detection apparatus based on parallel processing according to the present invention is applied includes an LTE uplink random access preamble detection apparatus 210 and a buffer 220.

The preamble detection apparatus 210 includes a generation unit 110 for calculating a random access preamble sequence using a root index and generating channel delay profile data using the random access preamble sequence and a channel delay profile generation input signal; a comparison unit 120 for generating a preamble start position value corresponding to the root index and comparing the preamble start position value with a channel delay profile index; and a detection unit 130 for detecting the peak value of the channel delay profile data if the preamble start position value is identical to the channel delay profile index.

The buffer 220 receives and stores the preamble data.

In this case, the buffer 220 transmits the channel delay profile generation input signal to the generation unit 110 if the storage of the preamble data has been completed.

For example, the buffer 220 may transmit a first channel delay profile generation input signal q_{1,in} to the generation unit 110 if the storage of the preamble data has been completed.

The generation unit 110 may calculate the random access preamble sequences using the root indices before the storage of preamble data in the buffer 220 is completed and may receive the channel delay profile generation input signal from the buffer if the storage of the preamble data in the buffer has been completed.

For example, before the storage of the preamble data in the buffer is completed, the generation unit 110 calculates a first random access preamble sequence using a first root index q₁, and may receive a first channel delay profile generation input signal q_{1,in} from the buffer and generate first channel delay profile data q_{1,out} in response to the first channel delay profile generation input signal if the storage of the preamble data in the buffer has been completed.

In this case, if the generation of the channel delay profile data has been completed, the generation unit 110 may convert an index corresponding to the channel delay profile data and generate a channel delay profile index.

If the generation of the channel delay profile data has been completed, the generation unit 110 may transfer the channel delay profile index to the comparison unit 120.

Further, if the generation of the channel delay profile data has been completed, the generation unit 110 may transfer the channel delay profile data to the detection unit 130.

In this case, the comparison unit 120 generates a preamble start position value corresponding to the root index and compares the preamble start position value with the channel delay profile index.

The comparison unit 120 may additionally generate preamble start position values corresponding to respective root indices in consideration of the shift of the peak value in the random access preamble sequence due to the Doppler effect.

In this case, the comparison unit 120 may transfer information about whether the preamble start position value is identical to the channel delay profile index to the detection unit 130.

If the preamble start position value is identical to the channel delay profile index, the detection unit 130 detects the peak value of the channel delay profile data.

If the preamble start position value is identical to the channel delay profile index, the detection unit 130 may accumulate pieces of channel delay profile data in preamble sections including preamble start position values for respective root indices and detect the peak value of the accumulated channel delay profile data.

In this way, in the system to which the LTE uplink random access preamble detection apparatus based on parallel processing according to the present invention is applied, the preamble detection apparatus 210 is configured such that, when the buffer 220 receives and stores preamble data and transmits a channel delay profile generation input signal to the preamble detection apparatus 210, the generation unit 110 of the preamble detection apparatus 210 calculates a random access preamble sequence using a root index and generates channel delay profile data using the random access preamble sequence and the channel delay profile generation input signal; the comparison unit 120 generates a preamble start position value corresponding to the root index and compares the preamble start position value with a channel delay profile index; and the detection unit 130 detects the peak value of the channel delay profile data if the preamble start position value is identical to the channel delay profile index.

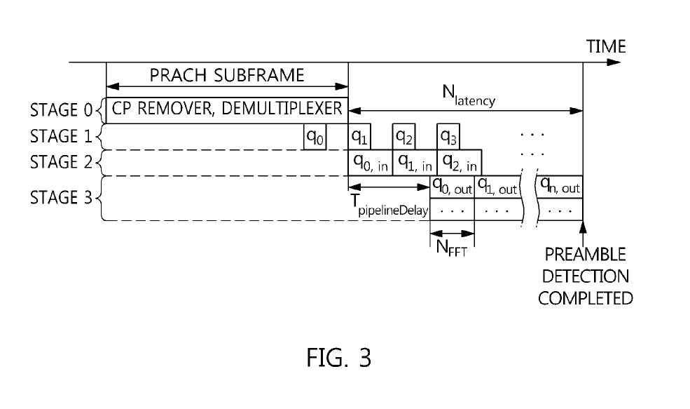

FIG. 3 is a diagram showing an example of parallel processing according to the present invention.

Referring to FIG. 3, it can be seen that parallel processing according to the present invention is parallel processing for the generation of pieces of channel delay profile data q_{1,out} to q_{n,out} respectively corresponding to a plurality of root indices q₁ to qₙ.

In this case, it can be seen that parallel processing related to the generation of pieces of channel delay profile data q_{1,out} to q_{n,out} respectively corresponding to a plurality of root indices q₁ to qₙ according to the present invention is implemented by a pipeline processing structure.

For example, parallel processing according to the present invention is configured to perform the generation of first channel delay profile data q_{1,out} corresponding to the first root index q₁ and the generation of second channel delay profile data q_{2,out} corresponding to the second root index q₂ in parallel.

In this way, the output of the second channel delay profile data q_{2,out} starts subsequently to the termination of the output of the first channel delay profile data q_{1,out} owing to parallel processing according to the present invention, so that the delay time other than the time T_{pipelineDelay} required to generate the first channel delay profile data may be reduced.

FIG. 4 is a diagram showing an example of channel delay profile data according to an embodiment of the present invention.

Referring to FIG. 4, channel delay profile data according to the present invention includes preamble start position values 411 to 413, preamble sections 421 to 423, and pieces of channel delay profile data 431 to 433 corresponding thereto.

In this case, it can be seen that the preamble start position values are indicated in Cᵥ₋ 411, Cᵥ 412, and Cᵥ₊ 413, which correspond to the case of a restricted set in which the Doppler effect is considered.

In the case of the restricted set, pieces of channel delay profile data in the preamble sections including preamble start position values are accumulated for respective root indices, and the peak value of the accumulated channel delay profile data is detected.

In this case, as a method of accumulating pieces of channel delay profile data in preamble sections including the preamble start position values for respective root indices, the channel delay profile index is gradually increased from 0 and is then made identical to the preamble start position value.

For example, this method is configured to, if the preamble start position values are Cᵥ₋ 411, Cᵥ 412, and Cᵥ₊ 413, gradually increase the channel delay profile index from 0, store the channel delay profile data 431 of a preamble section 421 including Cᵥ₋ 411 when the channel delay profile index is Cᵥ₋ 411, add the channel delay profile data 432 of a preamble section 422 including Cᵥ 412 to the data 431 and store accumulated data when the channel delay profile index is Cᵥ 412, and additionally add the channel delay profile data 433 of a preamble section 423 including Cᵥ₊ 413 to the accumulated data of the data 431 and the data 432, and detect the peak value of resulting data 435 when the channel delay profile index is Cᵥ₊ 413.

In this case, the pieces of channel delay profile data 431 and 432 may be stored in a memory block.

In this way, the influence of the shift of a peak value in a random access preamble sequence due to the Doppler effect may be reduced by accumulating pieces of channel delay profile data for respective root indices.

In this case, the LTE uplink random access preamble detection apparatus based on parallel processing according to the embodiment of the present invention may acquire preamble identifiers corresponding to preamble start position values if the peak value has been detected.

For example, the LTE uplink random access preamble detection apparatus based on parallel processing according to an embodiment of the present invention may acquire a preamble identifier corresponding to the preamble start position value 412 of the preamble section 422 in which a peak value is detected.

Further, the LTE uplink random access preamble detection apparatus based on parallel processing according to the embodiment of the present invention may acquire a distance to the base station using a difference between the corresponding preamble start position value and a peak position value if the peak value has been detected.

For example, the LTE uplink random access preamble detection apparatus based on parallel processing according to the embodiment of the present invention may acquire the distance to the base station using a difference between the preamble start position value 412 and the peak position value 415 of the preamble section 422 in which the peak value is detected.

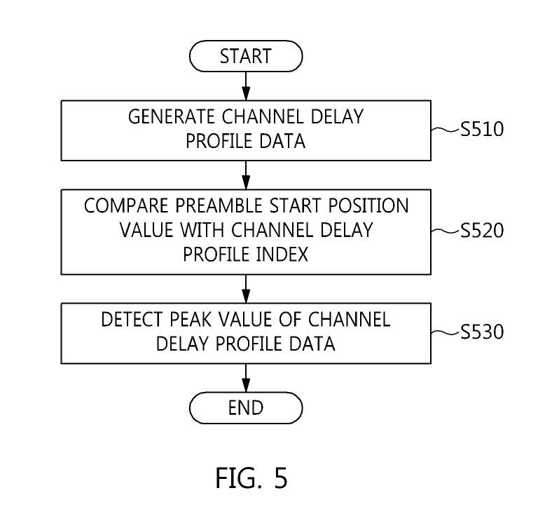

FIG. 5 is an operation flowchart showing an example of a method of detecting an LTE uplink random access preamble based on parallel processing according to an embodiment of the present invention.

Referring to FIG. 5, in the LTE uplink random access preamble detection method based on parallel processing according to the embodiment of the present invention, a random access preamble sequence is calculated using a root index, and channel delay profile data is generated using the random access preamble sequence and a channel delay profile generation input signal at step S510.

In this case, the value of the root index may be a value preset by a base station.

The root index may include a plurality of root indices.

Here, a single random access preamble sequence, a single channel delay profile generation input signal, and a single piece of channel delay profile data may correspond to a single root index.

For example, step S510 may be configured to calculate a first random access preamble sequence using a first root index q₁, and to generate first channel delay profile data by additionally using a first channel delay profile generation input signal.

In this case, step S510 may be configured to generate random access preamble sequences respectively corresponding to a plurality of root indices using the root indices so as to include a plurality of random access preambles in the random access preamble sequences.

Here, the length of each random access preamble sequence may be 839.

Further, the random access preamble sequence may be a Zadoff-Chu sequence.

Step S510 may be configured such that, before the storage of the preamble data in a buffer is completed, random access preamble sequences are calculated using root indices, and such that, if the storage of the preamble data in the buffer has been completed, a channel delay profile generation input signal is received from the buffer.

For example, step S510 may be configured such that, before the storage of preamble data in the buffer is completed, a first random access preamble sequence may be calculated using a first root index q₁, and such that, if the storage of the preamble data in the buffer is completed, a first channel delay profile generation input signal q_{1,in} is received from the buffer, and first channel delay profile data q_{1,out} may be generated in response to the first channel delay profile generation input signal q_{1,in}.

In this case, at step S510, generation of pieces of channel delay profile data q_{1,out} to q_{n,out} respectively corresponding to a plurality of root indices q₁ to qₙ may be processed in parallel.

Here, at step S510, the generation of pieces of channel delay profile data q_{1,out} to q_{n,out} respectively corresponding to the plurality of root indices q₁ to qₙ may be processed in a pipeline manner.

For example, step S510 may be configured to process the generation of the first channel delay profile data q_{1,out} corresponding to the first root index q₁ and the generation of the second channel delay profile data q_{2,out} corresponding to the second root index q₂ in parallel.

In this way, owing to the parallel processing performed at step S510, the output of second channel delay profile data q_{2,out} starts subsequently to the termination of the output of the first channel delay profile data q_{1,out} due to the parallel processing of the generation unit 110, so that the delay time other than the time T_{pipelineDelay} required to generate the first channel delay profile data may be reduced.

In this case, the time N_{FFT} required to detect the peak value of the channel delay profile data may be the time required to perform a FFT on the channel delay profile data.

The preamble data may be data in which a Cyclic Prefix (CP) part is eliminated from an uplink signal.

Further, the preamble data may be obtained by extracting a frequency interval including a random access preamble from a time interval (PRACH subframe) signal agreed upon between the base station and the terminal by using a demultiplexer.

Furthermore, the preamble data may be obtained by performing a FFT.

Furthermore, the preamble data may be obtained by performing OFDM demodulation.

Furthermore, the preamble data may be data of a frequency domain.

At step S510, an index corresponding to the channel delay profile data may be converted and then a channel delay profile index may be generated.

In this case, the index corresponding to the channel delay profile data may correspond to a value ranging from 0 to N.

At step S510, the index corresponding to the channel delay profile data may be proportionally converted into a value ranging from 0 to 838, and then the channel delay profile index may be generated.

Further, in the LTE uplink random access preamble detection method based on parallel processing according to the embodiment of the present invention, a preamble start position value corresponding to the root index is generated, and the preamble start position value is compared with the channel delay profile index at step S520.

In this case, step S520 may be configured to additionally generate preamble start position values respectively corresponding to root indices in consideration of the shift of the peak value in the random access preamble sequence due to the Doppler effect.

For example, step S520 may be configured to additionally generate preamble start position values on the left and right sides of the existing preamble start position value in consideration of the shift of the peak value in the random access preamble sequence due to the Doppler effect.

As described above, step S520 may be configured to generate three preamble start position values corresponding to a single root index in consideration of the shift of the peak value in the random access preamble sequence due to the Doppler effect.

In this case, step S520 may be configured to generate the preamble start position values allocated to the random access preamble sequence calculated using the root index.

Further, in the LTE uplink random access preamble detection method based on parallel processing according to the embodiment of the present invention, if the preamble start position value is identical to the channel delay profile index, the peak value of the channel delay profile data is detected at step S530.

In this case, at step S530, if the preamble start position value is identical to the channel delay profile index, the peak value of channel delay profile data in the preamble section including the preamble start position value may be detected.

For example, at step S530, if the preamble start position value is 0 and the channel delay profile index is 0, and then they are identical to each other, the peak value of the channel delay profile data in the preamble section including the preamble start position value of 0 may be detected.

In this case, step S530 is configured to, if the preamble start position value and the channel delay profile index are identical to each other, accumulate pieces of channel delay profile data in the preamble sections including preamble start position values for respective root indices, and detect the peak value of accumulated channel delay profile data.

The length of the preamble section may be a value preset by the base station.

Step S530 may be configured to, when the preamble start position value corresponds to a restricted set in which the Doppler effect is considered, accumulate pieces of channel delay profile data in the preamble sections including the preamble start position values for respective root indices, and detect the peak value of the accumulated channel delay profile data.

In this case, at step S530, the channel delay profile index is gradually increased from 0, and is made identical to the preamble start position value.

For example, step S530 may be configured to, if the preamble start position values are Cᵥ₋ 411, Cᵥ 412, and Cᵥ₊ 413, gradually increase the channel delay profile index from 0, store the channel delay profile data 431 of a preamble section 421 including Cᵥ₋ 411 when the channel delay profile index is Cᵥ₋ 411, add the channel delay profile data 432 of a preamble section 422 including Cᵥ 412 to the data 431 and store accumulated data when the channel delay profile index is Cᵥ 412, and additionally add the channel delay profile data 433 of a preamble section 423 including Cᵥ₊ 413 to the accumulated data of the data 431 and the data 432, and detect the peak value of resulting data 435 when the channel delay profile index is Cᵥ₊ 413.

In this case, the pieces of channel delay profile data 431 and 432 may be stored in a memory block.

In this case, step S530 may be configured to, when the preamble start position value corresponds to an unrestricted set in which the Doppler effect is not considered, detect the peak value of channel delay profile data in a preamble section including the preamble start position value.

In this way, step S530 may be configured to accumulate pieces of channel delay profile data processed in parallel, thus promptly obtaining accumulated channel delay profile data.

As described above, step S530 may be configured to reduce the influence of the shift of a peak value in a random access preamble sequence due to the Doppler effect by accumulating pieces of channel delay profile data for respective root indices.

In this case, the LTE uplink random access preamble detection method based on parallel processing according to the embodiment of the present invention may further include the step of, if the peak value has been detected, acquiring preamble identifiers corresponding to preamble start position values.

In this case, the number of preamble identifiers may be 64.

For example, the step of acquiring preamble identifiers may be configured to acquire a preamble identifier corresponding to the preamble start position value 412 of the preamble section 422 in which the peak value is detected.

Further, the LTE uplink random access preamble detection method based on parallel processing according to the embodiment of the present invention may further include the step of, if the peak value has been detected, acquiring a distance to the base station using a difference between the preamble start position value and a peak position value.

For example, the step of acquiring the distance to the base station may be configured to acquire the distance to the base station using a difference between the preamble start position value 412 and the peak position value 415 of the preamble section 422 in which the peak value is detected.

In accordance with the present invention, an LTE uplink random access preamble can be more rapidly detected by processing in parallel the generation of pieces of channel delay profile data respectively corresponding to one or more root indices.

Further, the present invention can compare preamble start position values corresponding to one root index due to the Doppler effect with a channel delay profile index, thus more promptly canceling the influence of the Doppler effect.

Furthermore, the present invention can previously prepare for a random access preamble sequence using a root index before the storage of preamble data in a buffer is completed, thus more rapidly generating channel delay profile data.

As described above, in the apparatus and method for detecting an LTE uplink random access preamble based on parallel processing according to the present invention, the configurations and schemes in the above-described embodiments are not limitedly applied, and some or all of the above embodiments can be selectively combined and configured so that various modifications are possible.

What is claimed is:

1. An apparatus for detecting a Long Term Evolution (LTE) uplink random access preamble based on parallel processing, comprising:
a generation unit for calculating a random access preamble sequence using a root index and generating channel delay profile data using the random access preamble sequence and a channel delay profile generation input signal;
a comparison unit for generating a preamble start position value corresponding to the root index and comparing the preamble start position value with a channel delay profile index; and
a detection unit for detecting a peak value of the channel delay profile data if the preamble start position value is identical to the channel delay profile index.

2. The apparatus of claim 1, wherein the generation unit processes generation of pieces of channel delay profile data respectively corresponding to a plurality of root indices in parallel.

3. The apparatus of claim 2, wherein the comparison unit additionally generates preamble start position values respectively corresponding to the root indices in consideration of a shift of the peak value in the random access preamble sequence due to Doppler effect.

4. The apparatus of claim 3, wherein the detection unit is configured to, if each preamble start position value is identical to the channel delay profile index, accumulate pieces of channel delay profile data in preamble sections including preamble start position values for respective root indices, and detect a peak value of the accumulated channel delay profile data.

5. The apparatus of claim 4, further comprising an identifier acquisition unit for acquiring preamble identifiers corresponding to the preamble start position values if the peak value has been detected.

6. The apparatus of claim 4, further comprising a distance acquisition unit for acquiring a distance to a base station using a difference between a corresponding preamble start position value and a peak position value.

7. The apparatus of claim 4, wherein the comparison unit generates the preamble start position values allocated to random access preamble sequences calculated using the root indices.

8. The apparatus of claim 4, wherein the generation unit is configured to,
before storage of preamble data in a buffer is completed, calculate random access preamble sequences using the root indices, and
if storage of the preamble data in the buffer has been completed, receive the channel delay profile generation input signal from the buffer.

9. The apparatus of claim 3, wherein the generation unit converts an index corresponding to the channel delay profile data and then generates the channel delay profile index.

10. The apparatus of claim 9, wherein the generation unit proportionally converts the index corresponding to the channel delay profile data into a value ranging from 0 to 838, and then generates the channel delay profile index.

11. A method of detecting a Long Term Evolution (LTE) uplink random access preamble based on parallel processing, comprising:
calculating a random access preamble sequence using a root index and generating channel delay profile data using the random access preamble sequence and a channel delay profile generation input signal;
generating a preamble start position value corresponding to the root index and comparing the preamble start position value with a channel delay profile index; and
detecting a peak value of the channel delay profile data if the preamble start position value is identical to the channel delay profile index.

12. The method of claim 11, wherein generating the channel delay profile data is configured to process generation of pieces of channel delay profile data respectively corresponding to a plurality of root indices in parallel.

13. The method of claim 12, wherein comparing the preamble start position value with the channel delay profile index is configured to additionally generate preamble start position values respectively corresponding to the root indices in consideration of a shift of the peak value in the random access preamble sequence due to Doppler effect.

14. The method of claim 13, wherein detecting the peak value of the channel delay profile data is configured to, if each preamble start position value is identical to the channel delay profile index, accumulate pieces of channel delay profile data in preamble sections including preamble start position values for respective root indices, and detect a peak value of the accumulated channel delay profile data

15. The method of claim 14, further comprising acquiring preamble identifiers corresponding to the preamble start position values if the peak value has been detected.

16. The method of claim 14, further comprising acquiring a distance to a base station using a difference between a corresponding preamble start position value and a peak position value.

17. The method of claim 14, wherein comparing the preamble start position value with the channel delay profile index is configured to generate the preamble start position values allocated to random access preamble sequences calculated using the root indices.

18. The method of claim 14, wherein generating the channel delay profile data is configured to,
before storage of preamble data in a buffer is completed, calculate random access preamble sequences using the root indices, and
if storage of the preamble data in the buffer has been completed, receive the channel delay profile generation input signal from the buffer.

19. The method of claim 13, wherein generating the channel delay profile data is configured to convert an index corresponding to the channel delay profile data and then generate the channel delay profile index.

20. The method of claim 19, wherein generating the channel delay profile data is configured to proportionally convert the index corresponding to the channel delay profile data into a value ranging from 0 to 838, and then generate the channel delay profile index.
